(19) United States
(12) Patent Application Publication
(10) Pub. No.: US 2010/0216084 A1
(43) Pub. Date: Aug. 26, 2010

(54) CONNECTION DEVICE FOR SURGICAL OPERATION OF STRAIGHTENING IRREGULAR TEETH

(76) Inventor: Yong Hyun Choi, Seoul (KR)

Correspondence Address: SHERR & VAUGHN, PLLC, 620 HERNDON PARKWAY, SUITE 320, HERNDON, VA, 20170, US

(21) Appl. No.: 12/681,710

(22) PCT Filed: Mar. 19, 2008
(86) PCT No.: PCT/KR08/01538

§ 371 Date: Apr. 5, 2010

(30) Foreign Application Priority Data
Oct. 4, 2007 (KR) 10-2007-0099935

(51) Int. Cl. A61C 3/00

(52) U.S. Cl. 433/8

(57) ABSTRACT

A connection device for a surgical operation of straightening irregular teeth is provided, which is used to connect a connection wire which connects brackets which are attached to respective teeth with a tension member which is connected with an anchor, to thereby reinforce intensity of the connection device and control height of the connection device, and to thus smoothen bodily movement of teeth. The connection device includes: a wire connection member in which a wire connection groove is formed horizontally lengthwise so that a connection wire is inserted into the wire connection groove; a hook connection member at the center of one end of which one end of the wire connection member is vertically fixed and in which a hook connection groove is formed vertically lengthwise; and a hook member at the lower end of which a fixing rod is formed in various lengths so as to be inserted into and fixed to the hook connection groove of the hook connection member, and at the upper end of which a hook is formed.

### TECHNICAL FIELD

The present invention relates to a connection device for a surgical operation of straightening irregular teeth, and more particularly, to a connection device for a surgical operation of straightening irregular teeth, which is used to connect a connection wire which connects brackets which are attached to respective teeth with a tension member which is connected with an anchor, to thereby reinforce intensity of the connection device and control height of the connection device, and to thus smoothen bodily movement of teeth.

### BACKGROUND ART

In general, in order to straighten teeth of a patient whose teeth are not straightened due to damage or deformity of teeth, a teeth straightening device called an orthodontics device is used.

In the case of the conventional orthodontics device, brackets are attached to respective teeth, and the brackets are pulled to straighten teeth.

The orthodontics device is largely divided into two methods, that is, a lip-side teeth straightening device and a tongue-side teeth straightening device, according to an installation place of the orthodontics device. The lip-side teeth straightening device is installed on the outer surface of the teeth to be straightened. The tongue-side teeth straightening device is installed on the inner surface of the teeth to be straightened. Patients prefer to the tongue-side teeth straightening device since it is not exposed to outside.

As illustrated in FIG. 1, in a conventional orthodontics device, brackets 2 are attached to teeth 1 which need to be straightened, and the brackets 2 are mutually connected via a connection wire 3. Here, a loop 9 of the connection wire 3 generates a rear tractive force.

However, the rear tractive forces of the conventional orthodontics device are generated at the lower side of the center of resistance (CR) of the front teeth. Accordingly, large forces are generated clockwise and thus the front teeth are rotated around the center of resistance (CR), to thereby cause a revolutionary slant movement of the front teeth.

Taking into account the above-described conventional problem, the connection wire is slanted in order to countervail clockwise forces which cause the front teeth to slantly move. Accordingly, the conventional orthodontics device has a problem that molars move forward or a fixing force of a fixing source for fixing the molars disappears.

Taking into account the above-described conventional problem, a conventional connection device for a surgical operation of straightening teeth is used as illustrated in FIG. 2.

As shown in FIG. 2, brackets 2 are attached to respective teeth 1 which need to be straightened, and the brackets 2 are mutually connected via a connection wire 3. Then, a tension member 4 such as an elastic rubber or spring is hung on the connection wire 3, to provide a tractive force. The tractive force of the teeth is maintained via a connection device 5 which connects the connection wire 3 with the tension member 4, and the tension member 4 is connected with an anchor 9′.

As shown in FIG. 3, the conventional connection device for a surgical operation of straightening teeth which is connected with the tension member 4, includes a wire connection member 7 in which a wire connection groove 6 into which a connection wire 3 is inserted is formed, and a hook 8 which is vertically fixed to one end of the wire connection member 7.

The conventional connection device of FIG. 3 can provide a rear tractive force toward the center of resistance (CR) of the teeth, to thereby prevent the front teeth from slantly moving, avoid a loss of a fixing source, and reduce size of a straightening force of teeth, and to thus derive a more physiological teeth transfer.

However, in the case of the conventional connection device, the tension member 4 is hung on the hook 8 so that the connection member 7 is fixed to the connection wire 3 to thus generate a tractive force from the connection wire 3. However, in the case that the center of resistance (CR) of teeth is high, the hook 8 is bent due to a load of the tractive force which is consecutively generated from the tension member 4 which is an elastic member, to thus cause the tractive force to be weakened. Further, since length of the whole hook 8 cannot be adjusted, the hook 8 should be welded on the center of resistance (CR) of teeth. As a result, the conventional connection device for a surgical operation of straightening teeth has caused an uncomfortable surgical operation of straightening teeth.

### DISCLOSURE OF INVENTION

### Technical Problem

Therefore, in order to supplement the shortcoming of the conventional art, it is an object of the present invention to provide a connection device for a surgical operation of straightening irregular teeth, which is used to connect a connection wire which connects brackets which are attached to respective teeth with a tension member which is connected with an anchor, in which a hook member which is of various lengths is inserted into and fixed to a hook connection member to thus adjust height of the connection device and to thereby reinforce intensity of the connection device and the hook connection groove and the wire connection groove are formed so as to be opened at various positions or in various directions so as to be fixed in correspondence to the tractive force.

### Technical Solution

To accomplish the above object of the present invention, there is provided a connection device for a surgical operation of straightening irregular teeth, the connection device comprising: a wire connection member in which a wire connection groove is formed horizontally lengthwise so that a connection wire is inserted into the wire connection groove; a hook connection member which is vertically fixed at the center of one end of the wire connection member and along one side of which a hook connection groove is formed vertically lengthwise; and a hook member at the lower end of which a fixing rod is formed in various lengths so as to be inserted into and fixed to the hook connection groove of the hook connection member, and at the upper end of which a hook is formed.

The wire connection groove in the wire connection member and the hook connection groove in the hook connection member are formed so as to be opened in opposite directions mutually or in an equal direction mutually and communicate with each other.

Alternatively, the wire connection groove in the wire connection member is formed so as to be opened downwards and the hook connection groove which is formed vertically lengthwise along one side of the hook connection member with respect to the wire connection member is formed so as to be opened at one side of the hook connection member.

### ADVANTAGEOUS EFFECTS

A hook which is used to connect a connection wire which connects brackets which are attached to respective teeth with a tension member which is connected with an anchor is inserted into and attached to a connection device for a surgical operation of straightening irregular teeth according to the present invention, to thereby reinforce intensity of the connection device.

In addition, a wire connection groove in a wire connection member and a hook connection groove in a hook connection member are formed so as to be opened at a variety of positions or in various directions, respectively, to thereby make the connection device fixed in correspondence to a tractive force which varies according to a respective position of teeth to be straightened.

Further, a hook member may be formed in various lengths, to thereby control height of the connection device in correspondence to the center of resistance (CR) of teeth, and to thus provide a rear tractive force toward the center of resistance (CR) of the teeth, to thereby prevent the front teeth from slantly moving, and to thus derive a more physiological teeth transfer without suffering from a loss of a fixing source.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### BRIEF DESCRIPTION OF THE DRAWINGS

FIG. 1 is a schematic view for explaining a surgical operation state of a conventional connection device which employs a loop of a connection wire for a surgical operation of straightening teeth;

FIG. 2 is a schematic view for explaining a surgical operation state of another conventional connection device which is connected with a tension member for a surgical operation of straightening teeth;

FIG. 3 is a perspective view showing the conventional connection device as shown in FIGS. 2 and 3, respectively;

FIG. 4 is a perspective view showing a disassembled connection device for a surgical operation of straightening teeth according to an embodiment of the present invention;

FIG. 5 is a perspective view showing an assembled connection device for a surgical operation of straightening teeth according to the embodiment of the present invention;

FIG. 6 is a cross-sectional view showing a state of using a connection device for a surgical operation of straightening teeth according to the embodiment of the present invention;

FIG. 7 is a perspective view showing a connection device for a surgical operation of straightening teeth according to another embodiment of the present invention, in which a hook connection member is not shown;

FIG. 8 is a perspective view showing a connection device for a surgical operation of straightening teeth according to still another embodiment of the present invention, in which a hook connection member is not shown; and

FIG. 9 is a schematic view for explaining a surgical operation state of using a connection device for a surgical operation of straightening teeth according to the present invention, respectively.

FIG. 10 is a schematic view for explaining a surgical operation state of using a connection device for a surgical operation of straightening teeth according to the present invention, respectively.

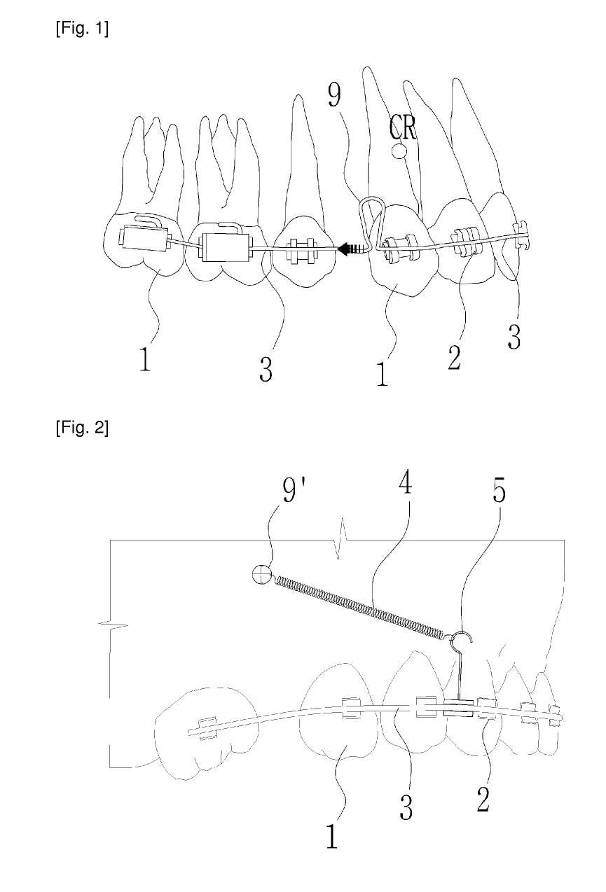

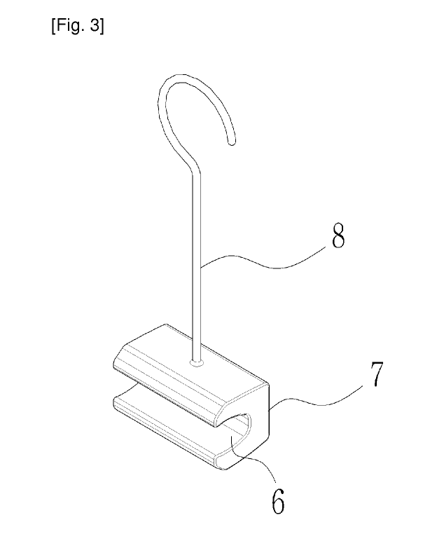

### BEST MODE FOR CARRYING OUT THE INVENTION

The present invention provides a connection device for a surgical operation of straightening irregular teeth, the connection device comprising: a wire connection member; a hook connection member; and a hook member at the lower end of which a fixing rod is formed in various lengths so as to be inserted into and fixed to a hook connection groove of the hook connection member, and at the upper end of which a hook is formed, in which a wire connection groove in the wire connection member and the hook connection groove in the hook connection member are formed so as to be opened in opposite directions mutually or in an equal direction mutually and communicate with each other, or the wire connection groove in the wire connection member is formed so as to be opened downwards and the hook connection groove which is formed vertically lengthwise along one side of the hook connection member with respect to the wire connection member is formed so as to be opened at one side of the hook connection member.

### MODE FOR THE INVENTION

Hereinbelow, a connection device for a surgical operation of straightening irregular teeth according to a respective preferred embodiment of the present invention will be described in more detail with reference to the accompanying drawings.

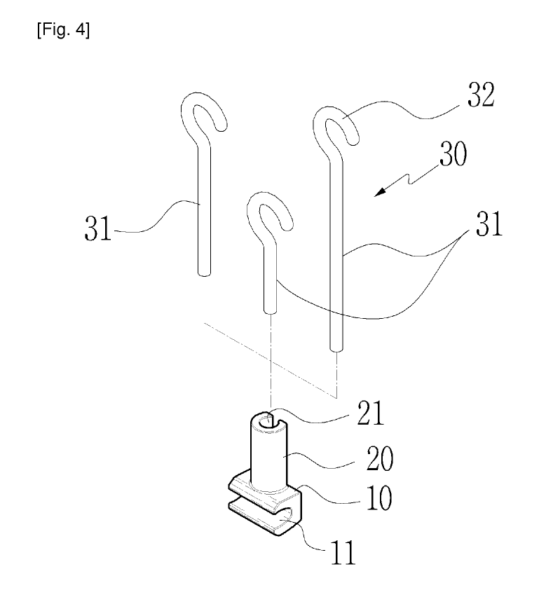

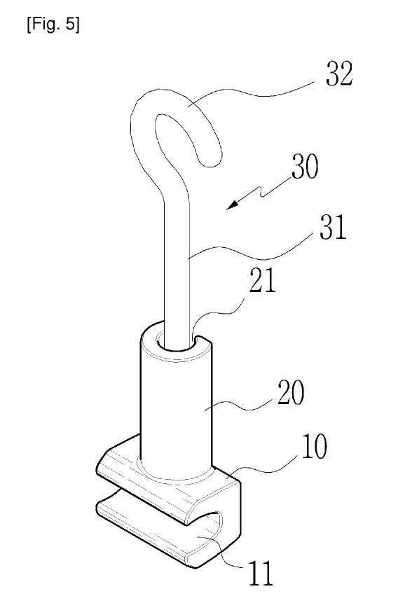

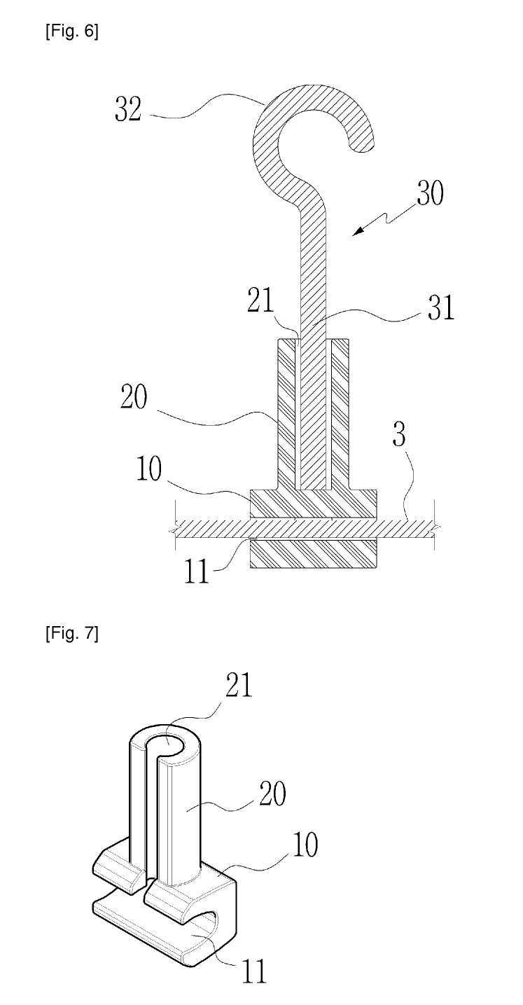

FIG. 4 is a perspective view showing a disassembled connection device for a surgical operation of straightening teeth according to an embodiment of the present invention. FIG. 5 is a perspective view showing an assembled connection device for a surgical operation of straightening teeth according to the embodiment of the present invention. FIG. 6 is a cross-sectional view showing a state of using a connection device for a surgical operation of straightening teeth according to the embodiment of the present invention.

As illustrated in FIGS. 4 to 6, a connection device for a surgical operation of straightening teeth according to an embodiment of the present invention includes a wire connection member 10 which is connected with a connection wire 3, a hook member 30 which is connection with a tension member 4, and a hook connection member 20 which is connected with the hook member 30.

A wire connection groove 11 is formed horizontally lengthwise in the wire connection member 10, so that a connection wire is inserted into the wire connection groove 11.

The hook connection member 20 is vertically fixed at the center of one end of the wire connection member 10. A hook connection groove 21 is formed vertically lengthwise along one side of the hook connection member 20. Here, a fixing rod 31 is formed so as to be inserted into and fixed to the hook connection groove 21 of the hook connection member 20.

The hook member 30 includes a fixing rod 31 and a hook 32. The fixing rod 31 may be formed of various lengths which is inserted into and fixed to the hook connection groove 21 of the hook connection member 20 and is formed at the lower end of the hook member 30 and the hook 32 is formed at the upper end of the hook member 30.

As illustrated in FIG. 6, in the case of the connection device for a surgical operation of straightening teeth according to an embodiment of the present invention, the wire connection groove 11 in the wire connection member 10 and the hook connection groove 21 in the hook connection member 20 are formed so as to be opened in opposite directions mutually. The connection wire 3 is fixed toward teeth. The hook member 30 is inserted into and fixed to the hook connection groove 21. Then, the tension member 4 (of FIG. 9A) is fixed along the outer side of teeth.

Meanwhile, as shown in FIG. 7, the wire connection groove 11 in the wire connection member 10 and the hook connection groove 21 in the hook connection member 20 may be formed so as to be opened in an equal direction mutually and communicate with each other. Accordingly, the connection wire 3 and the tension member 4 are connected with each other in an equal direction according to a teeth straightening direction, as shown in FIG. 9.

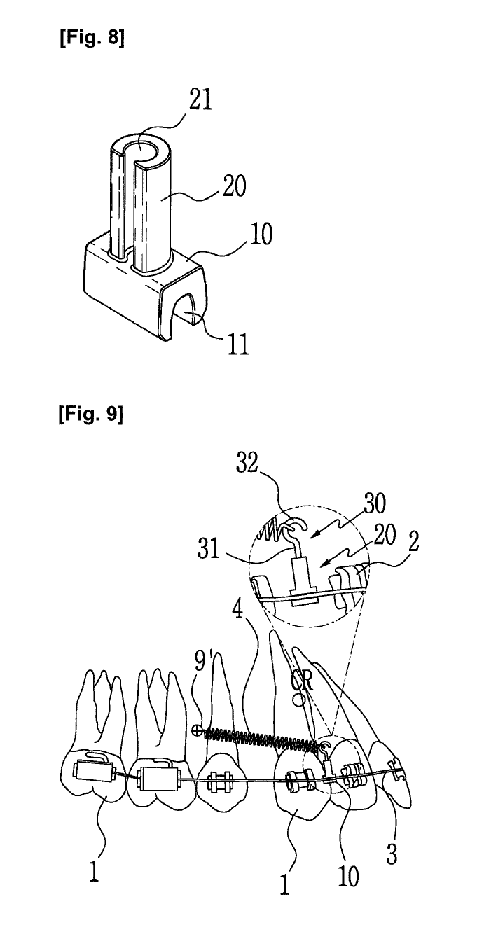

According to still another embodiment of the present invention, as shown in FIG. 8, the wire connection groove 11 in the wire connection member 10 may be formed so as to be opened downwards and the hook connection groove 21 which is formed vertically lengthwise along one side of the hook connection member 20 with respect to the wire connection member 10 may be formed so as to be opened at one side of the hook connection member 20. Accordingly, the connection wire 3 is connected with and fixed to the wire connection groove 11 and the hook member 30 is inserted into and fixed to the hook connection groove 21, as shown in FIG. 9.

The function and effect of this invention will follow.

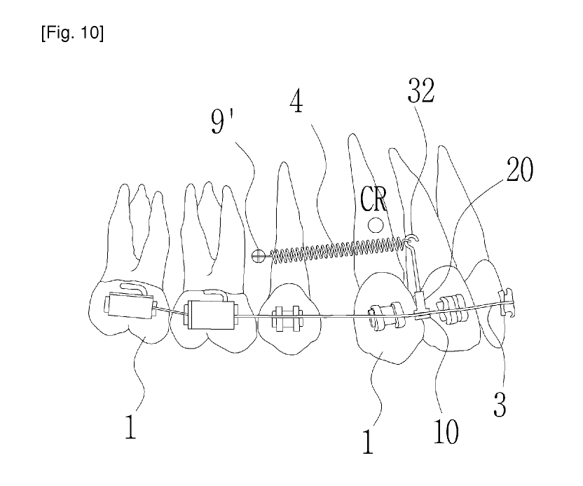

First, as illustrated in FIGS. 9 and 10, an anchor 9′ is fixed to the upper or lower jawbone and a tooth socket bone called an alveolar bone, and brackets 2 are attached to corresponding teeth 1, respectively.

The brackets 2 that are attached to the respective teeth 1 as mentioned are mutually connected with one another through the connection wire 3 and then the tension member 13 is connected with the anchor 9′.

The connection wire 3 and the tension member 13 which have been connected with each other are fixed through a connection device for a surgical operation of straightening teeth according to the present invention, to thereby provide a tractive force.

In the case of the connection device for a surgical operation of straightening teeth according to the present invention, the connection wire 3 is inserted into the wire connection groove 11 in the wire connection member 10, and then volume of the wire connection groove 11 in the wire connection member 10 is reduced using a pair of pinchers or pliers 3, to thus make the connection wire 3 fixed to the wire connection groove 11.

In addition, the tension member 4 is hung on and fixed to the hook 32 of the hook member 30.

The fixing rod 31 is inserted into the hook connection groove 21 formed in the hook connection member 20 and then volume of the hook connection groove 21 in the hook connection member 20 is reduced using a pair of pinchers or pliers 3, to thus make the hook member 30 fixed to the hook connection groove 21 of the hook connection groove 20.

As described above, in the case of the connection device for a surgical operation of straightening teeth according to the present invention, the hook member may be fixed in various lengths according to the center of resistance (CR) of teeth to be straightened, to then connect the connection wire and the tension member with the hook member, and to thus provide a tractive force. Accordingly, at the time of straightening teeth, a bodily movement of teeth and a transfer of roots of teeth can occur instead of a slant transfer of teeth.

### INDUSTRIAL APPLICABILITY

As described above, a connection device for a surgical operation of straightening irregular teeth according to the present invention can be applied in a teeth straightening device called an orthodontics device to straighten teeth of patients whose teeth are not straightened due to damage or deformity of teeth.

1-4. (canceled)

5. A connection device for a surgical operation of straightening irregular teeth, the connection device comprising:
a wire connection member in which a wire connection groove is formed horizontally lengthwise and configured for a connection wire to be inserted therein;
a hook connection member which is vertically fixed at the center of one end of the wire connection member, and has a hook connection groove formed vertically lengthwise along one side; and
a hook member having a hook formed at an upper end, and a fixing rod at a lower end configured to be formed with a variable length, and configured to be inserted into and fixed to the hook connection groove of the hook connection member.

6. The connection device according to claim 5, wherein the wire connection groove in the wire connection member and the hook connection groove in the hook connection member are formed with groove openings facing in mutually opposite directions.

7. The connection device according to claim 5, wherein the wire connection groove in the wire connection member and the hook connection groove in the hook connection member are formed with groove openings facing in the same direction, the groove openings in communication with each other.

8. The connection device according to claim 5, wherein the wire connection groove in the wire connection member is formed so as to be opened downwards and the hook connection groove which is formed vertically lengthwise along one side of the hook connection member with respect to the wire connection member is formed so as to be opened at one side of the hook connection member.
